(19) United States
(12) Patent Application Publication
(10) Pub. No.: US 2006/0146454 A1
(43) Pub. Date: Jul. 6, 2006

(54) Direct turbogenerator

(76) Inventor: Frank Wegner Donnelly, North Vancouver (CA)

Correspondence Address: SHERIDAN ROSS PC, 1560 BROADWAY, SUITE 1200, DENVER, CO, 80202, US

(21) Appl. No.: 10/533,402

(22) PCT Filed: Nov. 5, 2003
(86) PCT No.: PCT/CA03/01708

§ 371 Date: Dec. 6, 2005

(30) Foreign Application Priority Data
Nov. 15, 2002 (CA) 2,411,132

(51) Int. Cl. H02H 7/06

(52) U.S. Cl. 361/20

(57) ABSTRACT

A transformerless direct turbogenerator for generating electricity is provided. Since the introduction alternator comprises multiple parallel windings, it allows elimination of the need for a transformer.

### TECHNICAL FIELD

The invention relates to the field of power turbines used for power generation, and more particularly turbogenerators for generating electricity which use a cycloconverter.

### BACKGROUND

Gas turbines, either derived from aeroplane or industrial applications have been used and are being increasingly used to generate electrical power. Previously gas turbine power generation systems have used synchronous generators. In such systems, the gas turbine is connected to a gearbox to reduce the speed and then attached to a synchronous alternator. In recent times it has also been known to attach a high-speed alternator to produce rectified DC current and then produce usable AC by attaching an inverter.

The use of synchronous generators with a gas turbine to generate electric power has some disadvantages in that to maintain a constant frequency of the output either the speed of the generator must be kept constant or a frequency changer is required to convert the synchronous generator signal to an output signal with a precisely regulated frequency. It has been known to use an induction generator in place of a synchronous generator, with a signal handling circuit such as a frequency changer or cycloconverter to provide an output signal having a desired frequency and amplitude. See U.S. Pat. No. 3,832,625 Gyugi. Cycloconverters are used to convert AC power at a fixed frequency to AC power at a lower frequency. In such systems a transformer is generally required between the cycloconverter and the alternator or between the cycloconverter and the output. Such an arrangement requires a larger volume for the generator, and greater cost.

There is therefore a need for a transformerless turbogenerator.

### SUMMARY OF THE PREFERRED EMBO

This invention provides a new type of turbogenerator that is more direct and thus more efficient with a lower capital cost. The direct cycloconverter also eliminates the need for a gearbox but has the added advantage of avoiding the need for a DC ink.

The present invention therefore provides a turbogenerator having:
a) a turbine prime mover,
b) an induction alternator,
c) an excitation system for the induction alternator comprising a plurality of static capacitors and switches,
d) a cycloconverter connected to the induction alternator, and
e) a control circuit to control the excitation system and cycloconverter.

### BRIEF DESCRIPTION OF DRAWINGS

In drawings which illustrate a preferred embodiment of the invention:

FIG. 1 is a simplified schematic drawing of the direct turbogenerator of the invention connected to a utility power grid; and

FIG. 2 is a circuit diagram illustrating a preferred form of transformerless cycloconverter for use with the invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

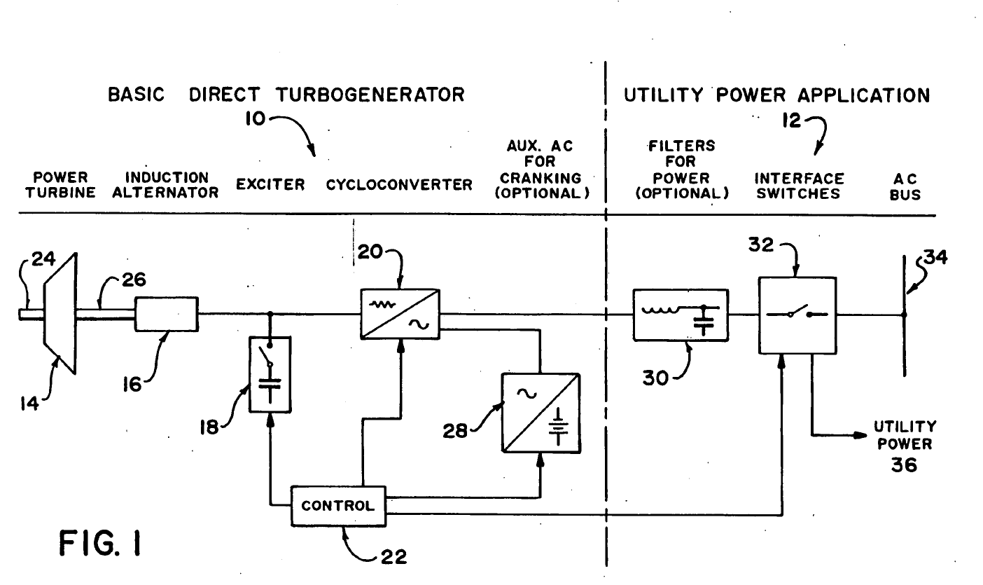

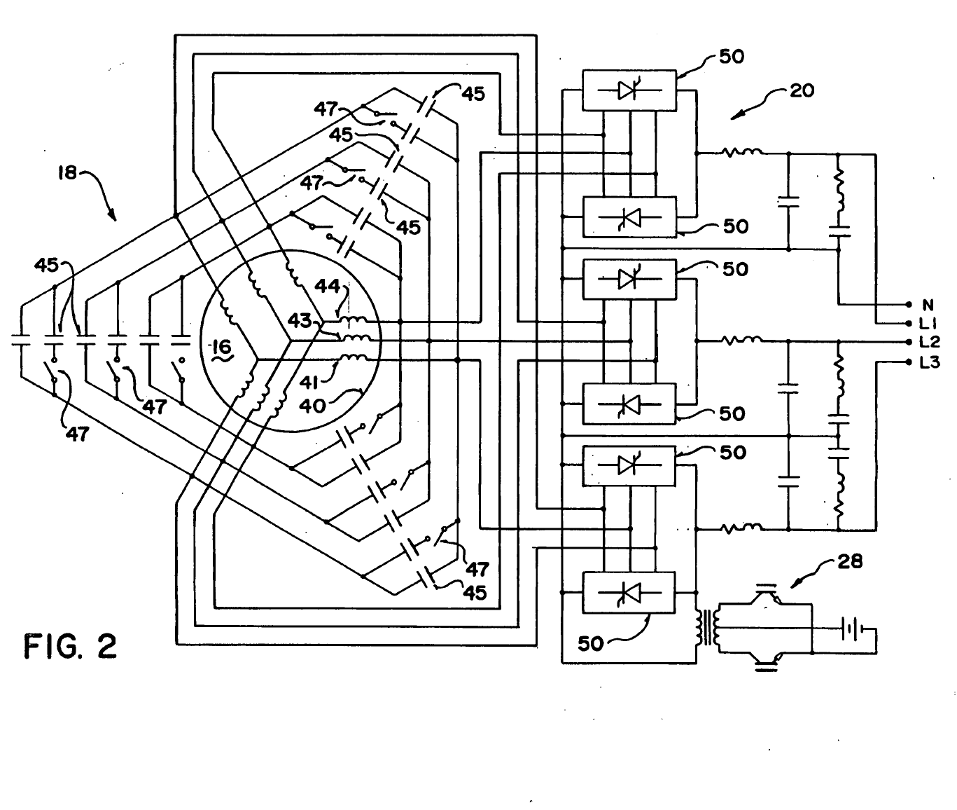

With reference to FIG. 1, the basic direct turbogenerator of the invention is designated as 10 with an adaptation 12 for connection to a utility power system. The direct turbogenerator 10 includes a power turbine 14, an induction alternator 16, exciter 18, cycloconverter 20 and control 22. It may also have an auxiliary source of AC power 28 (FIG. 2) for starting the gas turbine.

Power turbine 14, shown schematically in FIG. 1 on shaft 24 and having power shaft 26, is part of a gas turbine engine, the remaining parts, primarily the compressor and combustor, not being shown. The gas turbine of which power turbine 14 is a part will preferably be a micro-turbine, mini-turbine, or small gas turbine, having a power output in the general range of 25 kilowatts to 20 megawatts. Any type of gas turbine engine, whether simple cycle, recuperated or intercooled and recuperated may be used. The power turbine may be connected by shaft 24 to the compressor, as in a single spool gas turbine engine, or it may be on a separate shaft from the compressor, as in a double spool gas turbine engine. If a single spool gas turbine is used, an auxiliary AC power source may be provided in connection with the cycloconverter 20 to crank the shaft 26 to start the gas turbine.

Induction alternator 16 is coupled to power turbine 14 either directly by shaft 26 or through a gearbox (not shown). It is excited by exciter 18 which is a plurality of static capacitors and switches. Exciter 18 is controlled by controller 22, which may be for example a Programmable Logic Controller.

Where the turbogenerator is to be interfaced to a utility power system 36, filters 30 can be connected to the output. These may be smoothing reactor or LC filters. Interface switches 32 may also be connected, controlled by controller 22, to isolate the circuit from the utility grid in the event of outage surges, ground faults and the like. The output power is connected to AC Bus 34, to utility power 36 or both AC Bus 34 and utility power 36.

FIG. 2 is a circuit diagram illustrating the preferred circuit of the invention. Induction alternator 16 has three individual phase windings 41, 43, 44. Excitation is provided by a plurality of capacitors 45 and switches 47 arrayed around the stator 40. The switch/capacitor arrangement around the induction alternator stator 40 provides the necessary reactive power for the excitation of the alternator as well as a means of counteracting the effects of phase control current from the naturally commutated cycloconverter. This is an improvement over the past approaches where naturally commutated cycloconverters were connected to a synchronous alternator that supplied current with significant displacement from their internally produced voltages. This results in lower losses, higher efficiency and desired sizing and capital costs are achieved with this approach. Since the induction alternator comprises multiple parallel windings it allows elimination of the transformer

Cycloconverter 20 comprises a plurality of switches 50, preferably six. These may be silicon controlled rectifiers. Where an independent alternating current power source 28 back feeds the cycloconverter, it can be used to start the prime mover using the induction alternator.

The invention therefore provides in a preferred embodiment a transformerless turbogenerator comprising: a) a turbine prime mover; b) an induction alternator comprising a plurality of parallel windings; c) an excitation system for the induction alternator comprising a plurality of static capacitors and switches; d) a naturally commutated cycloconverter connected to the induction alternator, and e) a control circuit to control the excitation system and the cycloconverter.

As will be apparent from the foregoing, this invention has uses for both the production of electrical power at commercial power frequencies and driving of motors in applications such locomotives, ships and other vehicle applications.

As will be apparent-to-those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A turbogenerator comprising:
a) a turbine prime mover,
b) an induction alternator;
c) an excitation system for said induction alternator comprising a plurality of static capacitors and switches;
d) a cycloconverter connected to said induction alternator, and
e) a control circuit to control said excitation system and said cycloconverter

2. The turbogenerator of claim 1 wherein said induction alternator comprises a plurality of parallel windings thereby allowing elimination of a transformer.

3. The turbogenerator of claim 2 wherein said induction alternator comprises three parallel windings.

4. The turbogenerator of claim 1 further comprising an independent alternating current power source in circuit with said cycloconverter to permit starting of the prime mover using the induction alternator.

5. The turbogenerator of claim 1 wherein said cycloconverter is naturally commutated.

6. The turbogenerator of claim 5 wherein said cycloconverter comprises a plurality of switches.

7. The turbogenerator of claim 6 wherein said cycloconverter comprises a plurality of silicon controlled rectifiers.

8. The turbogenerator of claim 1 wherein said controller is a programmable logic controller.

9. A transformerless turbogenerator comprising:
a) a turbine prime mover;
b) an induction alternator comprising a plurality of parallel windings;
c) an excitation system for said induction alternator comprising a plurality of static capacitors and switches;
d) a naturally commutated cycloconverter connected to said induction alternator, and
e) a control circuit to control said excitation system and said cycloconverter

10. The turbogenerator of claim 9 further comprising an independent alternating current power source in circuit with said cycloconverter to permit starting of the prime mover using the induction alternator.

11. The turbogenerator of claim 9 wherein said induction alternator comprises three parallel windings.

12. The turbogenerator of claim 9 wherein said cycloconverter comprises a plurality of switches.

13. The turbogenerator of claim 12 wherein said cycloconverter comprises a plurality of silicon controlled rectifiers.

14. The turbogenerator of claim 9 wherein said controller is a programmable logic controller.
